(19) United States
(12) Patent Application Publication
(10) Pub. No.: US 2009/0195445 A1
(43) Pub. Date: Aug. 6, 2009

(54) SYSTEM AND METHOD FOR SELECTING PARAMETERS BASED ON PHYSICAL LOCATION OF A COMPUTER DEVICE

(76) Inventor: Ronald J. DeHaas, Corunna, MI (US)

Correspondence Address: DICKINSON WRIGHT PLLC, 1875 Eye Street, NW, Suite 1200, WASHINGTON, DC, 20006, US

(21) Appl. No.: 12/023,576

(22) Filed: Jan. 31, 2008

(51) Int. Cl. G01S 1/00; H04L 9/32; G06F 21/20; H04Q 7/24

(52) U.S. Cl. 342/357.01; 342/451; 726/3; 726/27; 370/338

(57) ABSTRACT

A system to predefine multiple allowed activities of a wireless computing device based on geographic location and, specifically, for security parameters associated with wireless access of such devices. Wireless access can be controlled on a movable computing device by ascertaining a geographic location of computing device, using a position sensing device; coupling motion sensing device with computing device; determining whether geographic location is within a predefined zone; and generating a command for controlling wireless access in response to determining. Commands can be derived from a predetermined table of allowed wireless activities in a geographically defined area and, specifically, for security parameters associated with the computing device. Wireless activities can include Internet protocols, instant messaging, email, and newsgroups. The commands can include blocking all wireless access, restricting file sharing, restricting Internet access, restricting email, restricting newsgroups, restricting instant messaging, and generating reports.

### CLAIM OF PRIORITY

None

### FIELD OF THE INVENTION

The present invention generally relates to a system and method to predefine multiple allowed activities of an electronic computing device both inside and outside of a geographically restricted area and, specifically, for wireless security parameters associated with such devices.

### BACKGROUND OF INVENTION

Recently, position determination systems have been manufactured that are adapted to couple to a computer (see generally U.S. Pat. No. 6,496,874 to Janky et al.). These position determination systems have been widely used in conjunction with laptop computers for mapping and surveying applications. Typically, such prior art position determination systems include a separate device, such as a global positioning device system (GPS), that is connected to the laptop computer using a PC card and a cable. One end of the cable attaches to the GPS device, and the other end attaches to the PC card. In order to attach this type of prior art GPS system to the laptop computer, the user must first insert the PC card into the PC card slot in the laptop computer. The user must then connect the cable to both the GPS device and to the PC card.

Also known in the art is the use of locating devices, such as GPS, to locate a personal electronic object, such as a laptop (see generally, U.S. Pat. No. 6,362,736 to Gehlot). In one instance, the locating device is triggered by a motion sensor, and a determination is made if the geographic location is within a predefined zone. For example, Nichols attempts to solve the problems of excessive battery drain or inadvertent cell phone calls in restricted zones, such as a movie theater. (See generally, U.S. Pat. No. 7,313,476 to Nichols et al.) The inventor refers to this as geo-fencing.

Unfortunately, while technologically possible, no one in the art has attempted to solve problems associated with various computer or Internet functions that could be or should be restricted outside of a predetermined geographic area (see generally, U.S. Ser. No. 11/969,378 to DeHaas, which is incorporated here by reference). For example, in the United States the Sarbanes-Oxley Act of 2002 has significant reforms in financial reporting and disclosure systems for publicly-traded companies. As part of this Act, publicly traded companies must maintain financial records in a way that provides reasonable assurance regarding prevention or timely detection of unauthorized acquisition, use or disposition of the registrant's assets that could have a material effect on the financial statements. When a computing device, such as a laptop computer, stores such financial records, there is no means of preventing unauthorized acquisition based on the location of the computing device. For example, when the computing device leaves the office, or other defined geographic area, there is no known means in the art for blocking the use of Internet connectivity or other computer applications from improper disclosure of this information.

Thus, there is a need for providing an application that predefines multiple allowed activities of an electronic computing device both inside and outside of a restricted area and, specifically, for security parameters associated with wireless access to these devices.

### SUMMARY OF INVENTION

Accordingly, the present invention provides a system and method to predefine multiple allowed activities of an electronic computing device both inside and outside of a geographically restricted area and, specifically, for security parameters associated with wireless access of such devices.

Specifically in one embodiment is provided a system and method for controlling wireless access of a movable computing device by ascertaining a geographic location of said computing device, using a position sensing device; coupling said motion sensing device with said computing device; determining whether said geographic location is within a predefined zone; and generating a command for controlling said wireless access in response to said determining.

Additional features of the system and method of the present invention include the detecting of motion of said device using a motion sensing device and coupling said motion sensing device with said positioning device, then determining geographic location upon each motion detected.

The present system can use a variety of positioning systems known in the art, such as a satellite-based position determining system, a terrestrial-based position determining system to determine said geographic location, and cellular-based systems.

Commands can be derived from a predetermined table of allowed wireless activities both inside and outside of a geographically restricted area and, specifically, for security parameters associated with the computing device. Generating a table of commands can include generating a whitelist (allowed activity); generating a blacklist (prohibited or restricted activity); generating a time chart for specific wireless uses with specified time parameters; and generating a list of reporting parameters to a third party. Wireless activities can include Internet protocols, instant messaging, email, and newsgroups. The commands can include blocking all wireless access, restricting file-sharing, restricting Internet access, restricting email, restricting newsgroups, restricting instant messaging, and generating reports.

Other commands to restrict wireless activity can include time features (time of day or duration) or security breaches.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figures below, in which like numerals represent like elements and in which:

FIG. 1 is a diagram of a position tracking system utilized in accordance with embodiments of the present invention.

FIG. 2 is a flowchart of a method for controlling wireless access of a computing device in accordance with embodiments of the invention.

### DETAILED DESCRIPTION OF THE INVENTION

The present invention provides a system and method to predefine multiple allowed activities of an electronic computing device both inside and outside of a geographically restricted area and, specifically, for security parameters associated with wireless access of such devices.

Although the present invention is particularly well suited for use with a laptop computer and shall be described with respect to this application, the methods and apparatus disclosed here can be applied to other high-value personal electronic objects, including pocket computers, palm computers, and computer systems, as well as other items.

Generally, in one embodiment of the present invention, a laptop is coupled to a positioning device. Optionally, a motion sensing device may be added to activate the positioning device to obtain a latitude and longitude of the device each time motion of the device is detected. This coupling of the various physical components of the present invention can be integral to the laptop or added through such means as an expansion slot. Various types of positioning devices are known in the art, such as a Global Positioning System (GPS), communication through specific cellular towers, radio waves, terrestrial based systems, and the like. For one embodiment, GPS is used. GPS is a reliable and highly accurate, three-dimensional navigation system. The GPS system consists of a number of satellites that orbit the earth twice a day, transmitting precise timing information. A network of ground stations and passive user receivers process information from several of the overhead satellites. Each satellite continuously broadcasts pseudo-random codes at L-band frequencies; for example, L1 and L2. L1 is modulated with two types of code, the coarse/acquisition code (CA-code) and precision code (P-code). L2 carries an encrypted P-code. The network of ground stations are at precisely known locations.

All GPS satellites contain a cesium clock, which is periodically compared with universal standard time at the ground stations. Corrections are transmitted to the satellites from the ground station. To determine a location (latitude, longitude, altitude, and time), a user requires the simultaneous signal from four or more satellites orbiting the earth. Simultaneous signals from at least three satellites can be used to provide two-dimensional positioning (latitude and longitude). The signals are analyzed and interpreted by the GPS receiver to determine the location. The interval between the transmission and the reception of the satellite signal is used to calculate a receiver's distance from each of the satellites being used. Those distances are used in algorithms to compute a position.

While high precision navigational data is necessary for some applications, lower precision data obtained from the coarse/acquisition code is sufficient, even without correction, for many applications. While the present invention is described utilizing the commercial form of GPS developed by the U.S., it is equally well-suited for use with other systems, such as the Russian GLONASS system.

Once a laptop is coupled to a positioning device, many useful applications can be developed. Such applications can include a computer program. Computer program or computer program product, in the present context, means any expression, in any language, code, or notation, of a set of instructions intended to cause a system having an information processing capability to perform a particular function, either directly or after either or both of the following: (a) conversion to another language, code, or notation; and (b) reproduction in a different material or electronic form. In addition, this system may include a subscription. The subscription service could be an individual, a group of persons, or an organization to which a user has subscribed and provided sufficient information to enable the subscription to send program information to the subscriber and/or directly to the system. The subscription service may be associated with a user fee or a subscription rate.

The present invention, in a digital format, can be realized as methods or systems in hardware, software, or a combination of hardware and software of a computer system, including a computer network system which may include the Internet. The present invention can be realized in a centralized fashion in one computer system or in a distributed fashion, where different elements are spread across several computer systems. Any kind of computer system or other apparatus adapted for carrying out the methods described herein is suited. A typical combination of hardware and software may include a general purpose computer system with a computer program that, when being loaded and executed, controls the computer system such that it carries out the systems and methods described herein. The present invention may also be voluntarily embedded in a computer program product (or any computer-usable medium having computer-readable program code embodied therein) which comprises all the features enabling the implementation of the methods and systems described herein and which, when loaded in a computer system, is able to carry out these systems and methods.

For the present invention, the issue of wireless laptop security can be addressed. Specifically, recognizing that security issues on a computer communicatively connected to the Internet are a growing problem, many software applications have been implemented to detect security violations and either block access to the Internet or notify a security guardian that a security violation has occurred. Security concerns and violations could include instant messaging, web surfing, email, or any other Internet protocol, including how they are used, the content thereof, or even the very access to one or more of those protocols. In a business or professional environment, there also are applications that are proprietary or utilize proprietary information. However, there is a growing utilization of laptops, PDAs, or other mobile computer devices, and there is a desire to establish a means of establishing security rules that may vary according to the location of the device. For instance, security at an office environment may be totally established, controlled, and monitored through a corporate proxy system, but when a laptop is taken from the office environment to another location, such as home or a coffee shop, the office security and proxy connection may not be able to be applied. There is, therefore, a need to detect where a computer device is geographically located (e.g., outside of boundaries of the secured office environment) in order to establish security criteria or at least an additional layer of security.

The present invention addresses this by utilizing the coupled positioning device to the laptop, which in turn is coupled to a computer program to monitor the position of the device and establishing security criteria for that computer device for that geographic location. Generally, the security parameter may, for illustrative purposes only, include: web surfing (access, or what may be added to interactive sites, or a whitelist or a blacklist), instant messaging (access, or control of who may be included as correspondents, or content), file-sharing (access, or control of content, or a whitelist or a blacklist), email (content, who should be included as correspondents, length, etc.), newsgroups (access, content, whitelist or blacklist) on any or all internet protocols. Other parameters can include monitoring time constraints (either time of day or total time per cay or other time unit); monitoring tampering or disabling of any of the features of the present invention, or any other types of security;

Once the parameters have been set, the system and method can execute various commands as to address these issues. For example, if use occurs in certain geographic areas at certain times, the system can disable wireless communication, send a report (or prepare an accessible report) that the criteria have been met to/for a third party (e.g., a notification report to another party, by telephone, internet, or other communication process). For example, the report can be provided to a security guardian that provides information on current location of monitored computers. The report can be available through a web interface or other communication process.

Other features can include having a security guardian that can change the security settings through a web interface or other communication process. Also, groups of users can be established that have different security rules. Again, the security guardian can change the security settings for a group through a web interface or other communication process. As to the content of a report, it can include an analysis of security violations as to priority of impact to business operations, legal ramifications, etc.

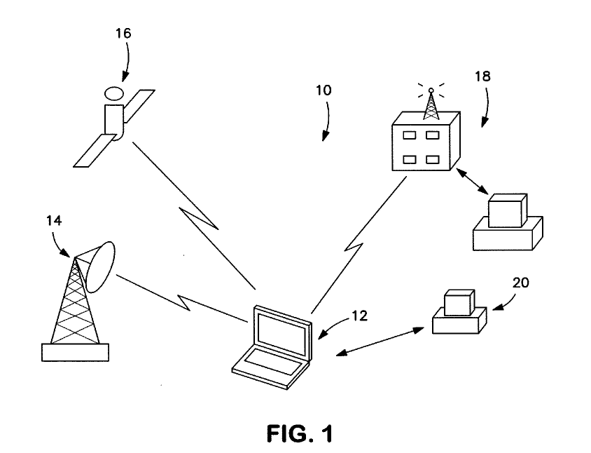

To illustrate one specific embodiment of the present invention, FIG. 1 is a diagram of a position tracking system utilized in accordance with embodiments of the present invention generally indicated at 10. System 10 includes a valuable computing device 12 that can be coupled with a wireless device and, optionally, an initiating component such as a motion sensing device (not shown), a satellite 16 or terrestrial 14 position determining system, and host system 20 (having a security guardian), and optionally a position tracking service provider 18. Within predetermined time intervals or optionally, when the computing device is moved, the geographic location is determined. Based on this location and other parameters such as time, wireless access type that is attempted, security violation, type of user, and the like, the system generates a command to control the computing device wireless access or generates a report.

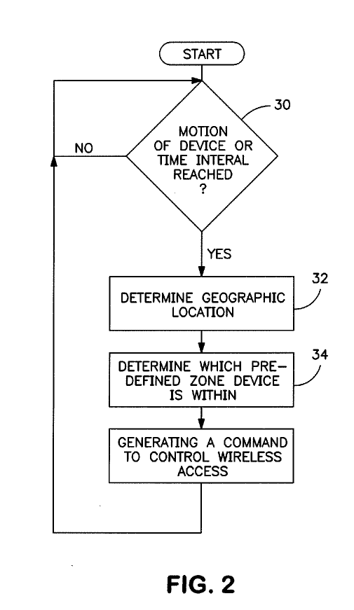

Shown in FIG. 2 is a flowchart of a method for controlling wireless access of a computing device in accordance with embodiments of the invention. The system starts at Step 30 and determines either or both of whether a certain time parameter or motion of the device has occurred. If no, the system returns back to step 30. If yes, the system moves to step 32 and determines the geographic location of the wireless device. Note that the operation of step 32 can be implemented in a variety of ways, as discussed above and known in the art. Additionally, the processing of data to determine the geographic location of the wireless computing device can be performed by the device itself or in conjunction with a remotely located server or computer (e.g., service provider 18 or host 20 of FIG. 1).

Once the geographic position of the device is known, the system moves to Step 34 to determine which predefined zone the device is within. For example, the zones can be open for areas within the physical zones of a business or within a predefined distance radius. Outside of these defined areas, wireless access may be controlled or restricted. The possibilities for the type and quantity of possible zones is limited only by the design parameters of the specific system.

Once the predefined zone is established, the system moves to Step 36 to generate a command to control wireless access, as described herein. Optionally, the system may also generate a command to control wireless access based on attempted security violations of the system, such as tampering or attempted disabling of the system. These commands can include limiting, reporting, or disabling wireless access of the system or even the computing device itself. Other commands are possible and still fall within the scope of the invention. Note that the commands can be stored and implemented in diverse ways. Also, the system may generate commands to wireless access of the device based on time of day, duration, or other parameters irrespective of combination of the geographic location of the computing device.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

1. A method for controlling wireless access of a movable computing device, comprising;
ascertaining a geographic location of said computing device using a position sensing device;
coupling said position sensing device with said computing device;
determining whether said geographic location is within a pre-defined zone; and
generating a command for controlling said wireless access comprising restricting file-sharing in response to said determining.

2. The method of claim 1, further comprising the steps of:
detecting motion of said computing device using a motion sensing device;
coupling said motion sensing device with said position sensing device; and
determining geographic location upon each motion detected.

3. The method of claim 1, wherein said ascertaining of said geographic location comprises using a satellite-based position determining system.

4. The method of claim 1, wherein said ascertaining of said geographic location comprises using a terrestrial-base position determining system to determine said geographic location.

5. The method of claim 1, wherein the step of generating a command is drawn from a table of allowed wireless activities both inside and outside of a geographically restricted area, said wireless activities based on security parameters associated with the computing device.

6. The method of claim 1 wherein wireless access is selected from the list of: Internet protocols, instant messaging, email, and newsgroups.

7. The method of claim 1, wherein the command for controlling said wireless access further comprises restricting Internet access.

8. The method of claim 1, further comprising the step of generating a table of commands by a security guardian.

9. The method of claim 8, wherein the step of generating a table of commands includes:
generating a whitelist;
generating a blacklist;
generating a time chart for specific wireless uses with specified time parameters; and
generating a list of reporting parameters to be sent to a third party.

10. The method of claim 9, wherein the step of generating a time chart includes parameters for time of day and or duration.

11. The method of claim 1, further comprising the steps of:
monitoring tampering of the controlling of the wireless access of the computing device; and
disabling said device in response to said tampering.

12. The method of claim 11, wherein tampering of the controlling is disabling the controlling of the wireless access of the device.

13. The method of claim 9, wherein the generating of a list of reporting parameters to be sent to a third party comprises generating an event and the geographic location of the computing device.

14. A method for controlling wireless access of a movable computing device, comprising:
ascertaining a geographic location of said computing device using a position sensing device;
coupling said position sensing device with said computing device;
determining whether said geographic location is within a pre-defined zone; and
generating a command for controlling said wireless access comprising restricting Internet access in response to said determining.

15. The method of claim 14, wherein the command for controlling said wireless access further comprises restricting email and restricting instant messaging.

16. The method of claim 14, wherein the command for controlling said wireless access further comprises restricting newsgroups.

17. A method for controlling wireless access of a movable computing device, comprising:
ascertaining a geographic location of said computing device, using a position sensing device;
coupling said position sensing device with said computing device;
determining whether said geographic location is within a pre-defined zone; and
generating a command for controlling said wireless access comprising restricting email and restricting instant messaging in response to said determining.

18. The method of claim 17, wherein the command for controlling said wireless access further comprises restricting file sharing.

19. The method of claim 17, wherein the command for controlling said wireless access further comprises restricting newsgroups.
